(19) United States
(12) Patent Application Publication
(10) Pub. No.: US 2025/0238233 A1
(43) Pub. Date: Jul. 24, 2025

(54) IN-MEMORY COMPUTING OF COMPLEX OPERATIONS

(71) Applicant: INTERNATIONAL BUSINESS MACHINES CORPORATION, Armonk, NY (US)

(72) Inventors: Tobias KOVATS, Zürich (CH); Navaneeth Rameshan, Zürich (CH); Kumudu Geethan KARUNARATNE, Zürich (CH); Abu SEBASTIAN, Zürich (CH)

(21) Appl. No.: 18/421,064

(22) Filed: Jan. 24, 2024

(51) Int. Cl. G06F 9/30

(52) U.S. Cl. CPC G06F 9/3004; G06F 9/30029; G06F 9/30032

(57) ABSTRACT

A plurality of operations is performed using an input encoded into a memory structure stored in memory of the computing environment to obtain a result. The plurality of operations includes one or more transformations of the input. The one or more transformations use one or more logical operators of a set of logical operators encoded in the memory structure. The result is transformed using a logical operator of the set of logical operators to obtain a transformed result. An output is determined based, at least, on the input and the transformed result. The output is provided to a computing device to be used in executing a computer process using the computing device.

### BACKGROUND

One or more aspects relate, in general, to processing within a computing environment, and in particular, to facilitating such processing.

Often, computer applications, including, but not limited to, those that perform secure communications within a computing environment perform many and/or complex operations. These operations include computations that may require substantial computer resources and processing time to perform.

### SUMMARY

Shortcomings of the prior art are overcome, and additional advantages are provided through the provision of a computer-implemented method of facilitating processing within a computing environment. The computer-implemented method includes performing a plurality of operations using an input encoded into a memory structure stored in memory of the computing environment to obtain a result. The plurality of operations includes one or more transformations of the input. The one or more transformations use one or more logical operators of a set of logical operators encoded in the memory structure. The result is transformed using a logical operator of the set of logical operators to obtain a transformed result. An output is determined based, at least, on the input and the transformed result. The output is provided to a computing device to be used in executing a computer process using the computing device.

Computer-implemented methods, computer systems and computer program products relating to one or more aspects are described and claimed herein. Each of the embodiments of the computer-implemented method may be embodiments of each computer system and/or each computer program product and vice-versa. Further, each of the embodiments is separable and optional from one another. Moreover, embodiments may be combined with one another. Each of the embodiments of the computer-implemented method may be combinable with aspects and/or embodiments of the computer system and/or computer program product, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of memory that includes processing logic, in accordance with one or more aspects of the present disclosure;

FIG. 3 depicts one example of routines performed for an Advanced Encryption Standard cryptographic technique, in which at least one of those routines is to use, as an example, one or more aspects of the present disclosure;

FIG. 4 depicts one example of processing during a mixColumns routine of the Advanced Encryption Standard cryptographic technique, which, as an example, is to use one or more aspects of the present disclosure;

FIG. 5 depicts one example of sub-modules of an in-memory computing module of FIG. 1, in accordance with one or more aspects of the present disclosure;

FIG. 6 depicts one example of an in-memory compute process, in accordance with one or more aspects of the present disclosure;

FIG. 7 depicts one example of a memory structure, such as a crossbar array, used in the in-memory computing, in accordance with one or more aspects of the present disclosure;

FIG. 8 depicts one example of a transformation process, in accordance with one or more aspects of the present disclosure; and

FIG. 9 depicts one example of post sense amplifier logic used in accordance with one or more aspects of the present disclosure.

### DETAILED DESCRIPTION

In accordance with one or more aspects of the present disclosure, a capability is provided to facilitate processing within a computing environment. In one or more aspects, the capability includes optimizing processing within the computing environment by using in-memory computing to perform complex operations. By using in-memory computing, performance is improved in performing the complex operations, as well as in performing processing that uses the complex operations.

In one or more aspects, the in-memory computing uses post sense amplifier logic in performing the complex operations such that writes back to memory (e.g., a memory structure, such as a crossbar array) are minimized (e.g., reduced or eliminated).

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of, e.g., performing in-memory computing and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

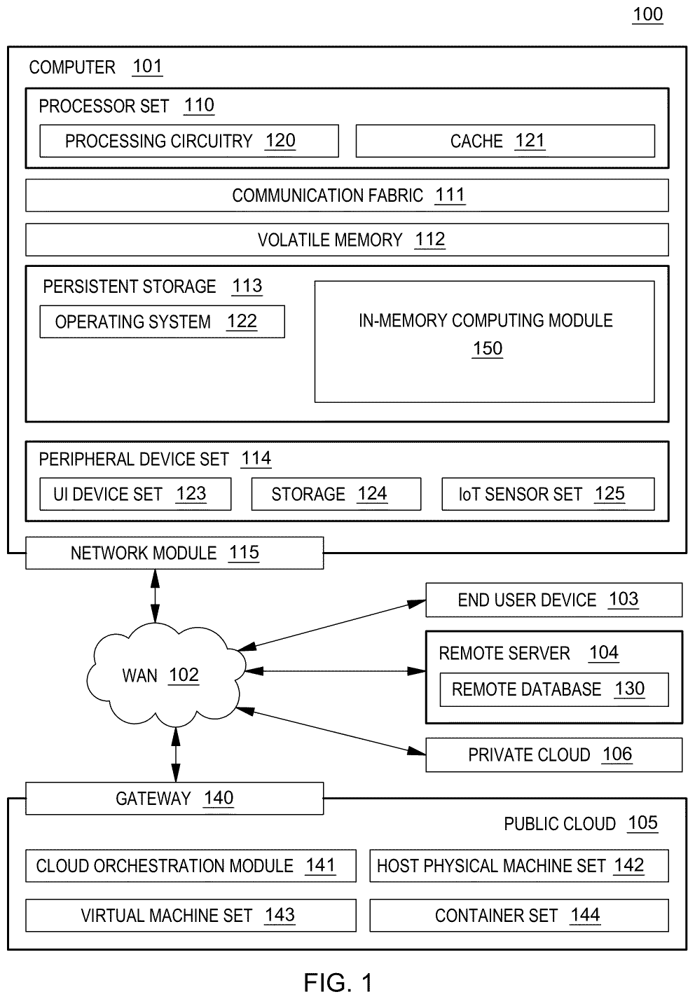

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as in-memory computing code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

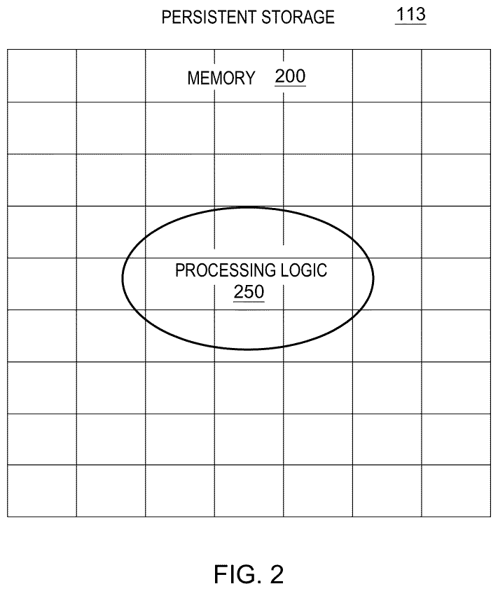

In one or more aspects, memory of the computing environment (e.g., persistent storage 113 of computing environment 100) is used in in-memory computing to perform one or more tasks. For instance, as depicted in FIG. 2, persistent storage 113 (and/or other storage) includes an area of memory 200 that stores data and further includes an area of memory that has processing logic 250 used to perform computing and/or processing, such as to perform tasks without requiring a write to a processor of, e.g., a processor set (e.g., processor set 110). The processing logic includes, for instance, memory devices and/or components having physical attributes used to compute in-place. As an example, such memory devices include, e.g., phase-change memory and/or other types of memory technologies.

In one example, tasks that are performed are complex operations, such as, but not limited to, in-memory finite field polynomial modular multiplications, the results of which are used in further computer processing, such as in encryption, decryption, encoding, etc. In one particular example, the finite field polynomial modular multiplications are performed as part of a mixColumns routine of an Advanced Encryption Standard (AES) cryptographic technique; however, it may be performed as part of and/or for other operations related and/or unrelated to the Advanced Encryption Standard, encryption, decryption and/or encoding. Many examples are possible.

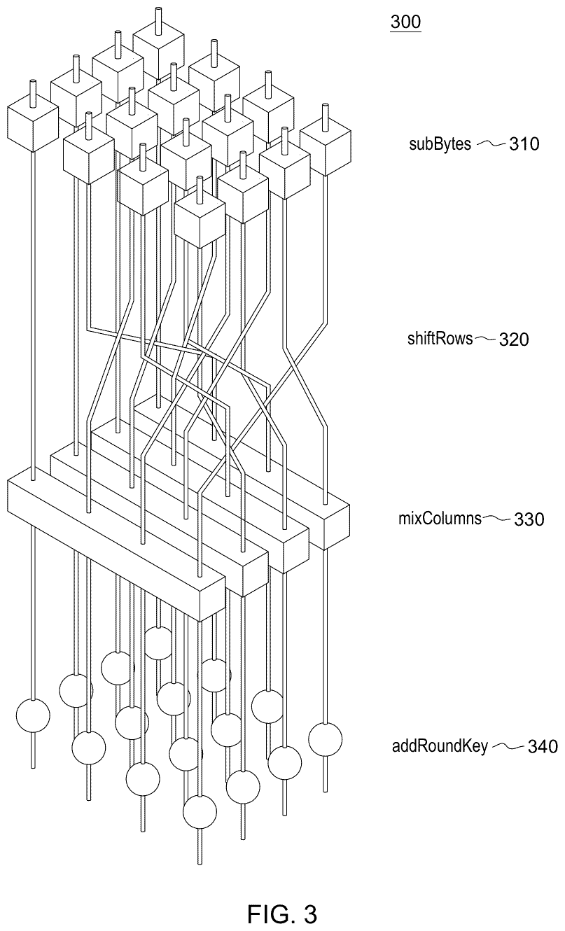

One example of the routines used by the Advanced Encryption Standard cryptographic technique, including mixColumns, is depicted in FIG. 3. The Advanced Encryption Standard operates on a 4×4 column-major order array of 16 bytes (e.g., a₀, a₁, . . . , a₁₅) termed the state. As an example, for the Advanced Encryption Standard 300, plain text is encoded in 4×4 states, and a plurality of routines is performed to encrypt the plain text. In one example, each routine uses in-memory computing and the states are stored in a crossbar array, an example of which is described herein.

One routine of the plurality of routines includes a subBytes routine 310 which performs a substitution of one byte in the array with another byte of data (as provided by, e.g., a look-up table). For instance, subBytes includes the following, as an example:
1 i←0; /*the state starts at row 0*/
2 while i≠4 do
3 \hat{r}←readRow(i);
4 \hat{r}←Sbox(\hat{r});
5 write(\hat{r}, i);
6 i←i+1;
7 end

Another routine used by the Advanced Encryption Standard is a shiftRows routine 320 that shifts the bytes in each row by an offset. For instance, shiftRows includes the following, as an example:

shiftRows
1 i←1; /*the state starts at row 0*/
2 while i≠4 do
3 \hat{r}←readRow(i);
4 j←0;
5 while j≠i do
6 \hat{r}←shift(\hat{r});
7 j←j+1;
8 end
9 write(\hat{r}, i);
10 i←i+1;
11 end

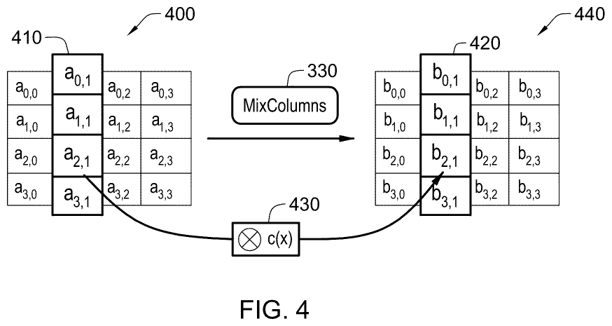

Another routine used by the Advanced Encryption Standard is a mixColumns routine 330 in which the four bytes of each column of the array are combined using, e.g., an invertible linear transformation to output four bytes. For instance, as shown in FIG. 4, in one example, the mixColumns routine takes four bytes of an input array 400 as input bytes 410 (e.g., one vector (e.g., column) of the array (or state)) and outputs four bytes 420 of an output array 440, in which each input byte affects all four output bytes.

In one example, each input vector 410 (e.g., column) of input array 400 is a polynomial which is multiplied by a constant polynomial 430 to provide an output polynomial 420 of an output array 440. For the Advanced Encryption Standard, the constant polynomial is, for instance, 3x³+x²+x+2 mod x⁴+1.

Returning to FIG. 3, another routine used by the Advanced Encryption Standard is an addRoundKey routine 340 in which a subkey is combined with the state. For instance, addRoundKey includes the following, as an example:
1 i←0; /*the state starts at row 0*/
2 while i≠4 do
3 \hat{r}←XOR(i, rk+i); /*the roundKey starts at row rk*/
4 write(\hat{r}, i);
5 i←i+1;
6 end

In accordance with one or more aspects, the mixColumns routine, at least, is performed in-memory to efficiently perform the polynomial multiplications of that routine. Although in this example, the complex operation performed in-memory is a polynomial multiplication, other complex operations may also be performed, in accordance with one or more aspects of the present disclosure. Polynomial multiplication is only one example.

In accordance with one or more aspects, an in-memory computing module (e.g., in-memory computing module 150) is used in performing the complex operations (e.g., polynomial multiplication). An in-memory computing module (e.g., in-memory computing module 150) includes code, logic and/or instructions used to perform in-memory computing, in accordance with one or more aspects of the present disclosure. In one example, the code, logic and/or instructions of the in-memory computing module (e.g., in-memory computing module 150) are implemented and/or executed in memory, such as in persistent storage 113. For instance, as depicted in FIG. 2, processing logic 250 is used in performing the in-memory computing.

In one example, an in-memory computing module (e.g., in-memory computing module 150) includes various sub-modules to be used to perform various processing. The sub-modules are, e.g., implemented as processing logic (e.g., processing logic 250) and/or as computer readable program code (e.g., instructions) in computer readable storage media, e.g., storage (persistent storage 113, cache 121, storage 124, other storage, as examples). The computer readable storage media may be part of one or more computer program products. A computer program product may include additional computer readable program code that may be executed by and/or using one or more computing devices (e.g., one or more computers, such as computer(s) 101 and/or other computers, etc.; one or more servers, such as remote server(s) 104 and/or other servers, etc.; one or more devices, such as end user device(s) 103 and/or other devices, etc.; one or more processors or nodes, such as processor(s) or node(s) of processor set 110 and/or other processor sets, etc.; processing circuitry, such as processing circuitry 120 of processor set 110 and/or other processor sets, etc.; and/or other computing devices, etc.). Additional and/or other computers, servers, devices, processors, nodes, processing circuitry and/or computing devices may be used. Many examples are possible.

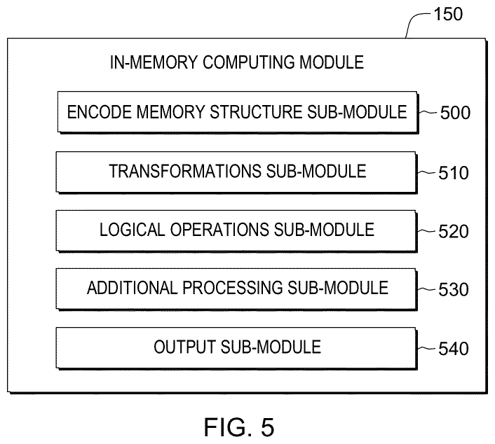

One example of in-memory computing module 150 is described with reference to FIG. 5. In one example, in-memory computing module 150 includes an encode memory structure sub-module 500 to encode a memory structure (e.g., an array, such as a crossbar array, etc.) to be used in one or more complex operations; a transformations sub-module 510 to perform one or more transformations using the memory structure; a logical operations sub-module 520 to perform one or more logical operations; an additional processing sub-module 530 to perform additional processing to determine an output; and an output sub-module 540 to provide the resulting output. In-memory computing module 150 may include additional, fewer and/or other sub-modules. Many variations are possible.

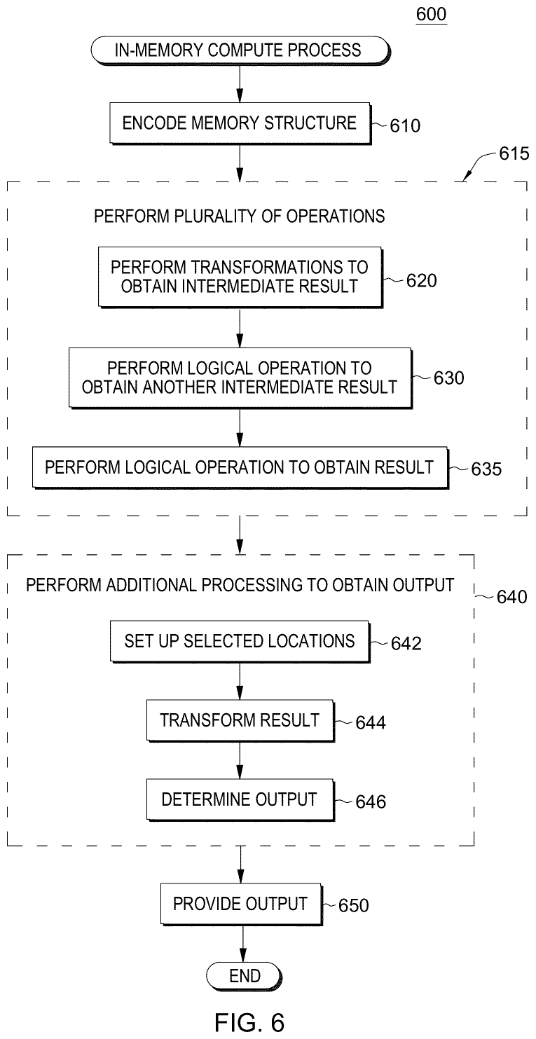

One or more sub-modules of the in-memory computing module are used in in-memory computing, as further described with reference to FIG. 6. In one example, an in-memory compute process is executed within memory (e.g., memory 200) using processing logic (e.g., processing logic 250) of the memory.

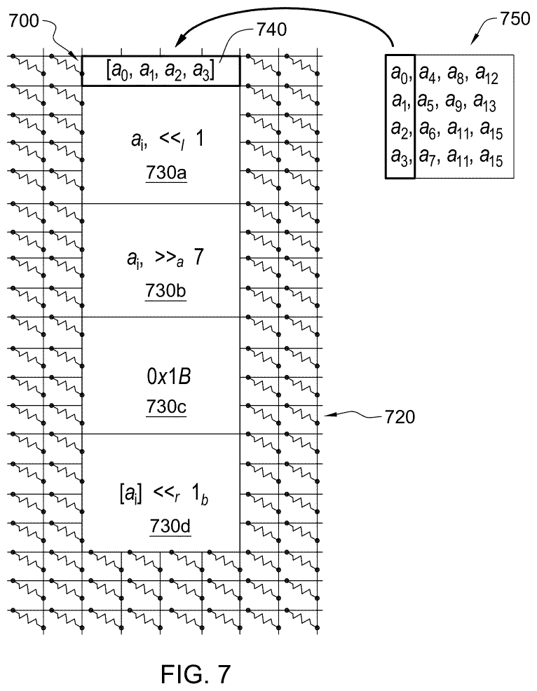

Referring to FIG. 6, in one example, in-memory compute process 600 (also referred to as process 600) is used to efficiently perform one or more complex operations (an example of a task) in-memory. In one example, process 600 performs an in-memory finite field polynomial modular multiplication. Initially, in one example, process 600 encodes 610 a memory structure, such as a crossbar array, with, for instance, an input polynomial (e.g., input 410) and further encodes the memory structure with a set of logical operators to be used in finite field polynomial modular multiplication of the input polynomial and a constant polynomial (e.g., constant polynomial 430) to produce an output polynomial (e.g., output 420). As an example, referring to FIG. 7, a crossbar array 700 located in memory 720 (e.g., persistent storage 113) is encoded with a set of logical operators 730a-730d used in transforming an input polynomial 740 (e.g., input polynomial 410) to an output polynomial (e.g., output polynomial 420). As an example, the input polynomial (e.g., input polynomial 740, input polynomial 410) is four bytes, and those four bytes are transformed to four output polynomial bytes (e.g., output polynomial 420). The input polynomial is, for instance, one polynomial of a plurality of polynomials 750 to be transformed to a plurality of output polynomials (see, e.g., FIG. 4, where each vector (e.g., column) representing an input polynomial 410 is transformed to another vector (e.g., column) representing an output polynomial 420).

Returning to FIG. 6, process 600 performs a plurality of operations 615 to obtain a result (e.g., a result of a finite field polynomial modular multiplication by three (represented herein as 3●R) using the input polynomial (e.g., R) and the constant polynomial). The plurality of operations includes, for instance, process 600 using one or more logical operators (e.g., operators 730a-730c) of the set of logical operators to perform a plurality of transformations 620 on the input polynomial to obtain an intermediate result, as described further below. Further, process 600 performs 630 a logical operation (e.g., an exclusive OR) on the intermediate result to obtain another intermediate result (e.g., a result of a finite field multiplication by two (e.g., 2●R) using the input polynomial and the constant polynomial). Moreover, process 600 performs 635 a logical operation (e.g., an exclusive OR) on the other intermediate result to obtain the result (e.g., 3●R). In one example, an exclusive OR is performed in-memory. As an example, for a phase-change memory device, a bit is stored within resistance of the device, and a voltage or current is applied to change the values of resistance. Other examples are possible.

Process 600 performs 640 additional processing to obtain an output (e.g., output 420). This additional processing includes, for instance, setting up 642 selected locations (e.g., memory or registers) through, for instance, a series of timesteps, transforming 644 the result (e.g., 3●R) using, e.g., a logical operator of the set of logical operators (e.g., logical operator 730d) to obtain a transformed result, and determining 646 the output (e.g., output 420) using, at least, the input and the transformed result. Process 600 provides 650 the output. For instance, process 600 provides the output to a processor (e.g., a processor of processor set 110). The processor may use the output in further processing, such as encryption, decryption, encoding, etc.

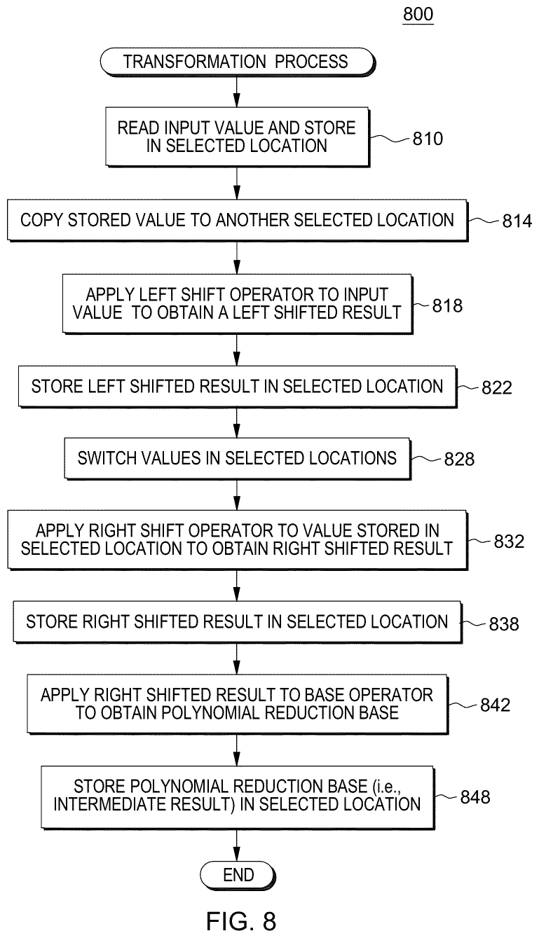

Further details relating to performing the transformations to obtain an intermediate result (e.g., transformations 620) and relating to other processing of FIG. 6 are described below. In one example, a transformation process is used to perform one or more transformations to produce the intermediate result. The transformation process employs, e.g., one or more sub-modules of in-memory computing module 150 (e.g., transformations sub-module 510), which uses in-memory processing logic (e.g., in-memory processing logic 250 (FIG. 2)) in performing the one or more transformations to produce the intermediate result. In describing one example of a transformation process, reference is made to FIGS. 7-8. For instance, reference is made to the memory structure (e.g., crossbar array) of FIG. 7 in describing a transformation process, an example of which is described with reference to FIG. 8.

Referring to FIG. 8, in one example, a transformation process 800 (also referred to as process 800), reads 810 (e.g., in one read cycle) an input value (e.g., input 740, input 410) encoded in the memory structure (e.g., crossbar array 700) and stores it in a selected location. In one example, the selected location is in memory (e.g., back to the memory structure or another area of memory). In another example, the selected location is a register. For convenience herein, the selected location is referred to as location B and the input value is referred to as R, and thus, R is stored in location B.

In one example, process 800 copies 814 the stored value to another selected location (e.g., in the memory structure or another area of memory, a register, etc.). For example, R is copied to a location C.

Process 800 applies 818 (e.g., in one read cycle) a left shift operator (e.g., aᵢ<<ₗ 1 (730a), where ₗ is logical for a logical shift) to the input value to obtain a left shifted result. In a logical shift to the left, in which the most significant bit (e.g., bit 7) and the least significant bit (e.g., bit 0) are stored in the leftmost and rightmost bit positions, respectively, the most significant bit is lost; the least significant bit is shifted by one bit to the left to position b_1. The new least significant bit is then 0. For example, for a byte [b7, b6, b5, b4, b3, b2, b1, b0]<<l1=[b6, b5, b4, b3, b2, b1, b0, 0]. Process 800 stores 822 the left shifted result in the selected location. For instance, R<<ₗ 1 is stored in location B. Process 800 switches 828 (e.g., in one clock cycle), in one example, the values in the selected location and the other selected location. For instance, the value stored in location B (e.g., R<<ₗ 1) is switched with the value stored in location C (e.g., R). Thus, after the switch, location B has R and location C has R<<ₗ 1.

Process 800 applies 832 (e.g., in one read cycle) a right shift operator (e.g., aᵢ>>ₐ 7 (730b), where ₐ is arithmetic for an arithmetic shift) to the input value (e.g., the value stored in the selected location (e.g., location B)) to obtain a right shifted result (e.g., R>>ₐ 7). In an arithmetic shift by seven to the right, the most significant bit is copied to all other bits when the byte is encoded with the most significant bit in the leftmost position. Thus, [b7, b6, b5, b4, b3, b2, b1, b0]>>_a7=[b7, b7, b7, b7, b7, b7, b7, b7]. Process 800 stores 838 the right shifted result in the selected location (e.g., location B).

Process 800 applies 842 (e.g., in one read cycle) the right shifted result to a base operator (e.g., 0x1B (730c)) to obtain a polynomial reduction base (e.g., (R>>ₐ 7)*0x1B, where * is multiplication). In one example, the base operator is an encoding of a part (e.g., mod x⁴+1) of the constant polynomial. Process 800 stores 848 the polynomial reduction base in the selected location (e.g., location B). This result is referred to herein as an intermediate result of the transformations.

Returning to FIG. 6 and with reference to FIGS. 6 and 7, a logical operation 630 is then performed on the intermediate result. For instance, in-memory compute process 600 performs (e.g., in one clock cycle) a logical operation (e.g., an exclusive OR) on the intermediate result stored in location B (e.g., (R>>ₐ 7)*0x1B) with the value in location C (e.g., R<<ₗ 1) to obtain another intermediate result (e.g., (R>>ₐ 7)*0x1B⊕R<<ₗ 1, where ⊕ is exclusive OR). This other intermediate result is the result of the finite field polynomial modular multiplication by two (represented herein as 2 ●R) for a selected vector (e.g., column) of the input array. In one example, at least one sub-module of in-memory computing module 150 (e.g., logical operations sub-module 520) is employed in performing the logical operation.

Further, process 600 performs 635 another logical operation (e.g., an exclusive OR) between the other intermediate result (e.g., 2 ●R) and the input vector (e.g., R) to obtain a result. This result is a finite field polynomial modular multiplication by three (represented herein as 3 ●R) for a selected vector (e.g., column).

Process 600 performs 640 additional processing to obtain an output (e.g., output vector (e.g., column) 420, FIG. 4). In one example, at least one sub-module of in-memory computing module 150 (e.g., additional processing sub-module 530) is employed in performing the additional processing. In one example, this processing is embedded into the mixColumns routine and includes initially setting up the selected locations (e.g., locations B and C) to include the appropriate values. As an example, in a first timestep, the input vector R is stored in location B and the other intermediate result (e.g., 2 ●R) is stored in location C. Then, 2●R is moved to location B and the result (e.g., 3 ●R) is stored in location C. Next, the values in locations B and C are switched, such that 3 ●R is stored in location B and 2●R is stored in location C.

Further, in one example, this additional processing includes, for instance, process 600 transforming 644 the result (e.g., 3●R) using, e.g., logical operator 730d (FIG. 7) to perform a byte left shifted operation of the result to provide a transformed result. For example, [aᵢ]<<1_{b} is applied to 3●R to obtain (3●R)<<1_{b}. In one example, this transformed result is stored in location B, and 2 ●R continues to be stored in location C.

Process 600 determines 646 the output of the input polynomial (e.g., input 740, input 410) multiplied by the constant polynomial (e.g., constant 430), which is the output polynomial (e.g., output 420). The determining employs, in one example, the input array (e.g., R), the other intermediate result (e.g., 2 ●R), the result (e.g., 3 ●R) and the transformed result (e.g., (3 ●R)<<1_{b}).

In one example, the determining includes storing the input vector R in location B, performing a logical operation (e.g., exclusive OR) between the transformed result and the other intermediate result to provide an outcome (e.g., ((3 ●R)<<1_{b})⊕((2 ●R)), and storing the outcome in location C.

Further, in one example, a right shift byte operation is performed on the input vector to shift the input to the right by 1 byte and that one byte shifted vector (e.g., R<<1_{b}) is stored in location B and location C remains the same. Further, a right shift byte operation is performed on the input vector to shift the input to the right by 2 bytes and that two byte shifted vector (e.g., R<<2_{b}) is stored in location B and location C remains the same. Further, a right shift byte operation is performed on the input vector to shift the input to the right by 3 bytes and that three byte shifted vector (e.g., R<<3_{b}) is stored in location B. Further, an exclusive OR is performed, in one example, between the outcome in location C with R<<2_{b} to provide another outcome of ((3 ●R)<<1_{b})⊕((2 ●R)⊕R<<2_{b}). Additionally, a further exclusive OR is performed, in one example, between the other outcome in location C with R<<3_{b} to provide the output (e.g., ((3 ●R)<<1_{b})⊕(2 ●R)⊕(R<<2_{b})⊕(R<<3_{b}), which is the final output (e.g., output 420) of a finite field polynomial modular multiplication between the input (e.g., input 410) and the constant polynomial.

In one or more embodiments, one or more of the above operations are optional. For instance, in one or more embodiments, one or more of the copying, switching and/or other operations may be optional. This may depend on whether the selected location and other selected location is in memory or a register and/or how the selected/other selected locations are being used.

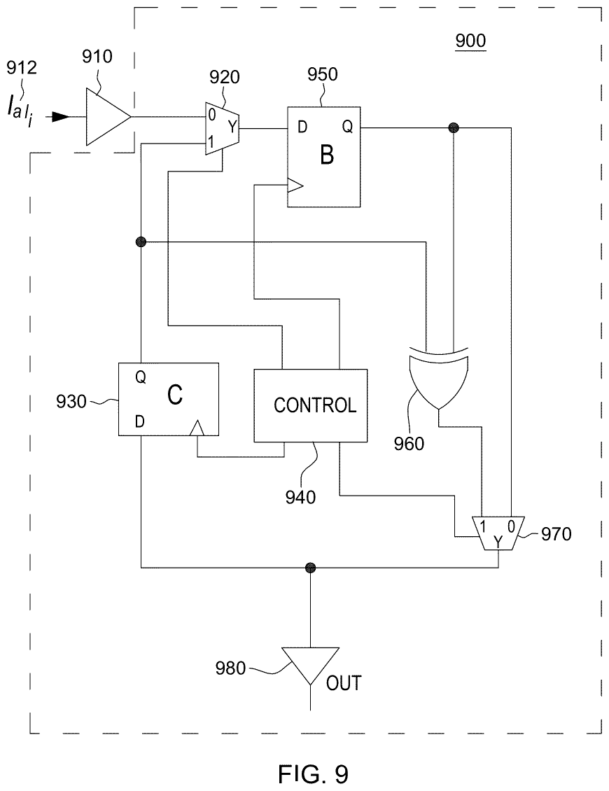

In one example, to optimize the in-memory compute process, post sense amplifier logic is used, instead of storing back into the memory structure (e.g., crossbar array) and/or memory. One example of post sense amplifier logic is described with reference to FIG. 9. In one example, post sense amplifier logic 900 is coupled to a sense amplifier 910. In one example, there is post sense amplifier logic 900 for each bit line; however, in one example, sense amplifier 910 may be shared among several bit lines. The post sense amplifier logic is coupled to, but separate from, the memory (e.g., memory 720), in one example.

Sense amplifier 910 receives as input an analog input current representing a bit 912 of an input byte and converts the analog current to a digital signal. The digital signal is input to a multiplexer 920 of post sense amplifier logic 900. Another input to multiplexer 920 is a register 930 of post sense amplifier logic 900, referred to as register C (an example of location C). Register 930 is further coupled to a control 940 of post sense amplifier logic 900, which is also input as a control to multiplexer 920. Control 940 is further coupled to another register 950 of post sense amplifier logic 900, referred to as register B (an example of location B). Registers 930 and 950 are also inputs to an exclusive OR gate 960 of post sense amplifier logic 900, an output of which is input to another multiplexer 970 of post sense amplifier logic 900. Control 940 is also a control input to multiplexer 970. The output of multiplexer 970 is provided as output 980.

In accordance with one or more aspects, post sense amplifier logic is used to perform the operators encoded within the crossbar array. The processing described with reference to FIG. 8 is performed, and location B is register B 950 of post sense amplifier logic 900 and location C is register C 930 of post sense amplifier 900.

Although in accordance with one or more aspects, post sense amplifier logic is used, this is only one embodiment. In other embodiments, the post sense amplifier logic is not used; instead, for instance, the memory structure and/or memory is used to store values (e.g., bytes) during the processing. Other variations are possible.

In one or more aspects, a complex operation is performed in parallel. As an example, the complex operation is a polynomial modular multiplication, in which, for instance, multiple bytes of a polynomial are multiplied by a constant polynomial in parallel. In one or more aspects, an in-memory compute architecture and technique enable high parallelization within a single instance of in-memory compute hardware. In one or more aspects, instead of relying on look-up tables, which require serialization and degrade performance, an in-memory memory structure, such as a crossbar array, is used in in-memory computing to encode the polynomial to be multiplied, along with the logical operators used in the multiplication. The logical operators are encoded as conductance patterns in the memory structure. The memory structure and operators are employed to perform transformations to the polynomial stored within the memory structure. Through a composition of transformations, in one example, polynomial modular multiplication is computed. For instance, by applying a vector (e.g., column) of voltages to the crossbar array, the transformation is performed. This is combined with, e.g., an in-memory XOR such that linear transformations over a finite field (2ⁿ) are performed. In one or more aspects, the in-memory logical operators may be written and deleted at runtime, providing flexibility. In one or more aspects, the multiplication includes computing byte-shifted polynomials at runtime, which is more space efficient and reduces the amount of energy-intensive writes. In one or more aspects, post sense amplifier logic is used to reduce the amount of write-backs to memory during performance of the complex operation.

By optimizing the processing (e.g., finite field polynomial multiplication), the results of the processing may be used to improve processing of other computer operations, such as secure communications, cryptographic operations (e.g., digital signatures and/or key exchanges that use multiplication), blockchains and/or other operations that use such processing (e.g., finite field polynomial multiplication). By increasing the speed and decreasing the cost of implementing selected computations, such as finite field polynomial multiplication, the secure communications, cryptographic operations, blockchains and/or other operations within the computer are improved.

In one or more aspects, since in-memory polynomial modular multiplications are performed in parallel on multiple vectors (e.g., rows), the mixColumns routine used, e.g., for the Advanced Encryption Standard, can be performed in parallel on multiple vectors (e.g., columns) and even multiple states in constant time. Further, in one or more aspects, the post sense amplifier logic allows the chaining of row-wise operations together and avoids writes to the memory structure. Using this polynomial modular multiplication approach, the Advanced Encryption Standard bottleneck typically encountered is overcome. Further, other techniques, such as, but not limited to, ring learning with errors, may benefit from one or more aspects. Many techniques may use one or more aspects of the present disclosure.

Other variations and embodiments are possible.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to implement finite field polynomial multiplication in-memory and/or to perform one or more other aspects of the present disclosure.

One or more aspects of the present disclosure are tied to computer technology and facilitate processing within a computer, improving performance thereof. For instance, processing speed is increased, and storage requirements and costs are reduced. One or more aspects provide parallel processing and low latency. Processing within a processor, computer system and/or computing environment is improved.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

Yet a further aspect, a process for integrating computing infrastructure comprising integrating computer readable code into a computer system may be provided. The computer system comprises a computer readable storage medium, in which the computer readable storage medium comprises one or more embodiments. The code in combination with the computer system is capable of performing one or more embodiments.

Although various embodiments are described above, these are only examples. For example, other circuits and/or logic may be used. Further, other complex operations may be performed in-memory to facilitate such processing, improving performance. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating processing within a computing environment, the computer-implemented method comprising:
performing a plurality of operations using an input encoded into a memory structure stored in memory of the computing environment to obtain a result, the plurality of operations including one or more transformations of the input, the one or more transformations using one or more logical operators of a set of logical operators encoded in the memory structure;
transforming the result using a logical operator of the set of logical operators to obtain a transformed result;
determining an output based, at least, on the input and the transformed result; and
providing the output to a computing device to be used in executing a computer process using the computing device.

2. The computer-implemented method of claim 1, wherein the logical operator includes a left byte shift operator.

3. The computer-implemented method of claim 1, wherein the one or more logical operators include a left shift operator, a right shift operator and a base operator.

4. The computer-implemented method of claim 1, wherein the input is an input polynomial, the output is an output polynomial, and the plurality of operations is used in performing a polynomial modular multiplication of the input polynomial and a constant polynomial to produce the output polynomial.

5. The computer-implemented method of claim 4, wherein the constant polynomial is provided by a standard used in encryption.

6. The computer-implemented method of claim 1, wherein the performing the plurality of operations includes:
performing a left shift operation on the input, using a left shift operator of the set of logical operators, to obtain a left shifted result;
performing a right shift operation on the input, using a right shift operator of the set of logical operators, to obtain a right shifted result;
applying a base operation on the right shifted result, using a base operator of the set of logical operators, to obtain an intermediate result;
performing a logical operation between the intermediate result and the left shifted result to obtain another intermediate result; and
performing another logical operation between the another intermediate result and the input to obtain the result.

7. The computer-implemented method of claim 1, wherein the set of logical operators is encoded at runtime.

8. The computer-implemented method of claim 1, wherein the memory structure comprises a crossbar array, and the input is an input vector of bytes of an input array and the output is an output vector of bytes of an output array, the input vector of bytes representing an input polynomial and the output vector of bytes representing an output polynomial.

9. The computer-implemented method of claim 1, wherein the memory includes a plurality of memory structures, and wherein the performing the plurality of operations includes performing the plurality of operations using a plurality of inputs encoded in a plurality of memory structures using a plurality of sets of operators encoded in the plurality of memory structures.

10. The computer-implemented method of claim 1, wherein the one or more transformations are performed using post sense amplifier logic coupled to the memory.

11. A computer system for facilitating processing within a computing environment, the computer system comprising:
a computing device; and
a memory coupled to the computing device, the memory including a memory structure, the memory structure having encoded therein an input and a set of logical operators, the memory further including processing logic to be used to perform the following computer operations including:
perform a plurality of operations using the input encoded into the memory structure to obtain a result, the plurality of operations including one or more transformations of the input, the one or more transformations using one or more logical operators of the set of logical operators encoded in the memory structure;
transform the result using a logical operator of the set of logical operators to obtain a transformed result;
determine an output based, at least, on the input and the transformed result; and
provide the output to a computing device to be used in executing a computer process using the computing device.

12. The computer system of claim 11, wherein the input is an input polynomial, the output is an output polynomial, and the plurality of operations is used in performing a polynomial modular multiplication of the input polynomial and a constant polynomial to produce the output polynomial.

13. The computer system of claim 11, wherein the perform the plurality of operations includes:
performing a left shift operation on the input, using a left shift operator of the set of logical operators, to obtain a left shifted result;
performing a right shift operation on the input, using a right shift operator of the set of logical operators, to obtain a right shifted result;
applying a base operation on the right shifted result, using a base operator of the set of logical operators, to obtain an intermediate result;
performing a logical operation between the intermediate result and the left shifted result to obtain another intermediate result; and
performing another logical operation between the another intermediate result and the input to obtain the result.

14. The computer system of claim 11, wherein the memory structure comprises a crossbar array, and the input is an input vector of bytes of an input array and the output is an output vector of bytes of an output array, the input vector of bytes representing an input polynomial and the output vector of bytes representing an output polynomial.

15. The computer system of claim 11, wherein the one or more transformations are performed using post sense amplifier logic coupled to the memory.

16. A computer program product for facilitating processing within a computing environment, the computer program product comprising:
a set of one or more computer readable storage media; and
program instructions, collectively stored in the set of one or more computer readable storage media, for causing processing logic to perform the following computer operations including:
perform a plurality of operations using an input encoded into a memory structure stored in memory of the computing environment to obtain a result, the plurality of operations including one or more transformations of the input, the one or more transformations using one or more logical operators of a set of logical operators encoded in the memory structure;
transform the result using a logical operator of the set of logical operators to obtain a transformed result;
determine an output based, at least, on the input and the transformed result; and
provide the output to a computing device to be used in executing a computer process using the computing device.

17. The computer program product of claim 16, wherein the input is an input polynomial, the output is an output polynomial, and the one or more transformations are used in performing a polynomial modular multiplication of the input polynomial and a constant polynomial to produce the output polynomial.

18. The computer program product of claim 16, wherein the perform the plurality of operations includes:
performing a left shift operation on the input, using a left shift operator of the set of logical operators, to obtain a left shifted result;
performing a right shift operation on the input, using a right shift operator of the set of logical operators, to obtain a right shifted result;
applying a base operation on the right shifted result, using a base operator of the set of logical operators, to obtain an intermediate result;
performing a logical operation between the intermediate result and the left shifted result to obtain another intermediate result; and
performing another logical operation between the another intermediate result and the input to obtain the result.

19. The computer program product of claim 16, wherein the memory structure comprises a crossbar array, and the input is an input vector of bytes of an input array and the output is an output vector of bytes of an output array, the input vector of bytes representing an input polynomial and the output vector of bytes representing an output polynomial.

20. The computer program product of claim 16, wherein the one or more transformations are performed using post sense amplifier logic coupled to the memory.
